(19) United States
(12) Patent Application Publication
(10) Pub. No.: US 2004/0159966 A1
(43) Pub. Date: Aug. 19, 2004

(54) Method for manufacturing extrusion molding with smooth surface and extrusion molding apparatus

(75) Inventor: Takayuki Yamaguchi, Aichi (JP)

Correspondence Address: OLIFF & BERRIDGE, PLC, P.O. BOX 19928, ALEXANDRIA, VA, 22320, US

(73) Assignee: TOKAI KOGYO CO., LTD, Obu-city (JP)

(21) Appl. No.: 10/754,690

(22) Filed: Jan. 12, 2004

(30) Foreign Application Priority Data
Jan. 14, 2003 (JP) P. 2003-006206

(51) Int. Cl. B29C 47/90

(52) U.S. Cl. 264/40.6; 425/378.1; 425/380; 264/211.12

(57) ABSTRACT

A method for manufacturing an extrusion molding with a smooth surface. An apparatus having a die and a sizing equipment is supplied with a molding material of thermoplastic resin. A heat conducting member is disposed within a flow channel of the die, and its tapered distal end portion is penetrated into a shaping flow channel beyond an orifice of the die. The molding material in molten state is introduced through the orifice into the shaping flow channel, and a solidified extrusion molding having a predetermined cross-sectional shape is exhausted out of the sizing equipment. Heat is supplied from the heat conducting member to the molding material, so that a molten portion remains when the molding material passes the distal end portion. Surface of the molding material is pressed against an inner wall face of the shaping flow channel due to a pressing force of the molten portion.

### BACKGROUND OF THE INVENTION

1. Field of the Invention

The present invention relates to a method for manufacturing an extrusion molding including a long resin molding that is attached to a vehicle such as automobile or a building, and more particularly to a method for manufacturing an extrusion molding with a smooth surface and an apparatus for manufacturing such extrusion molding.

2. Background Art

A long resin molding (extrusion molding) produced by extruding the molding material including thermoplastic resin is utilized as ornamental or structural material in various uses for the vehicle such as automobile or the building.

One of the extrusion molding methods to manufacture such extrusion molding is well known, which involves connecting an extruder, an extrusion die and a sizing equipment, introducing a molding material in molten state that is extruded through an orifice (extrusion opening) of the die into a flow channel within the sizing equipment, cooling the molding material within the flow channel, and exhausting a solidified resin molding out of the sizing equipment. For example, an extrusion molding method and an extrusion molding apparatus of this type were described in JP-A-2001-113587.

By the way, some of the extrusion moldings are particularly required to have the smooth surface for the purpose of enhanced ornamentation or close adhesion with other members. For example, there are various kinds of ornamental trim materials (e.g., decorative trimming member, roof molding) for the vehicle or building for the purpose of ornamentation, and various kinds of connecting materials (heat insulators) are disposed between metallic sash members for building for the purpose of close adhesion.

However, it was difficult to produce the resin molding with smooth surface by the conventional extrusion molding method. Particularly, when the molding material containing, in addition to thermoplastic resin, a relatively large amount of powder (or grain) like and/or fiber like solid filler was employed, it was difficult to realize the smooth surface meeting the above requirements.

### SUMMARY OF THE INVENTION

It is an object of the present invention to provide a method for easily manufacturing an extrusion molding (resin molding) with a smooth surface contributing to enhanced ornamentation or close adhesion. Also, it is another object of the invention to provide an apparatus for easily manufacturing the extrusion molding with smooth surface by practicing the method.

In order to accomplish the above object, the invention provides a method for manufacturing an extrusion molding with a smooth surface from a molding material of thermoplastic resin, including the following steps (a) and (b).

That is, (a) step includes supplying a molding material of thermoplastic resin to an extrusion molding apparatus, the extrusion molding apparatus comprising an extrusion die connected to an extruder and having a molten resin flow channel for flowing a heated and molten resin and an orifice with a predetermined opening shape, and a sizing equipment connected to the die and having a shaping flow channel with a smooth inner wall face having a cross-sectional shape conforming to the opening shape of the orifice, one or more heat conducting members for supplying heat to the molding material in a molten state flowing through the flow channel are disposed in the longitudinal direction of the flow channel within the molten resin flow channel of the die, a distal end of the heat conducting member being penetrated into the shaping flow channel beyond the orifice, and tapered.

Also, (b) step includes exhausting a resin molding having a predetermined cross-sectional shape substantially in a solid state out of the sizing equipment by introducing the molding material in molten state through the orifice into the sizing equipment to surround the heat conducting member and passing the molding material while cooling the molding material from the outer surface side by contact with an inner wall face of the shaping flow channel, in which the temperature of the inner wall face is adjusted to a lower temperature than a melting temperature of the molding material.

And the (b) step includes retarding the cooling of the molding material around the heat conducting member by supplying a heat from the heat conducting member to the molding material to leave a molten portion within the molding material at the time of passing the distal end of the heat conducting member (typically flowing the molding material in the molten portion faster than the outer surface), whereby the surface of the molding material is pressed against the inner wall face of the shaping flow channel due to an expansion pressure (pressing force) of the molten portion to form a smooth outer surface of the molding by transfer, the molding material being solidified while being moved downstream.

In this specification, the “thermoplastic resin” is a generic term of synthetic resin, rubber and elastomer indicating thermoplastic property.

According to the manufacturing method, the smoothness on the inner wall face of the shaping flow channel is transferred onto the outer surface of the molding in a process where the molding material in molten state extruded through the orifice of the die (i.e., unsolidified molding shaped in a predetermined cross section. In the following, to distinguish from the fully solidified resin molding, the molding being solidified in the course of extrusion may be often referred to as a “shaped molding material”) is solidified from the surface side within the sizing equipment (shaping flow channel). At this time, since the heat conducting member is disposed near the orifice in the molten resin flow channel and the shaping flow channel, the molding material in molten state introduced into the shaping flow channel has a molten portion within the molding material at least at the time of passing the distal end of the heat conducting member. Therefore, since the molten portion is subjected to a liquid pressure, an outside solidified portion can be pressed against the inner wall face of the shaping flow channel due to its expansion pressure. Also, the molding material is positively refilled in a region where the molten resin is cooled and solidified, whereby the shaped molding material is prevented from shrinking in volume, when solidified, and the unwanted depression called a “sink mark” is prevented from occurring on the surface of the resin molding.

Moreover, since the distal portion of the heat conducting member disposed within the shaping flow channel is tapered (typically the area of cross section is gradually decreased toward the distal end; tapered shape), the flow of molten portion is prevented from being disordered (i.e., the molten resin is greatly varied in the flowing direction and the f low rate) before and after passing the distal end of-the heat conducting member. That is, before and after the shaped molding material passes the distal end of the heat conducting member, variations in the expansion pressure of the molten portion applied on the outer solidified portion is suppressed.

Accordingly, with the manufacturing method, the surface of the shaped molding material is pressed stably against the inner wall face of the shaping flow channel until the solidification is fully completed. Thereby, with this manufacturing method, it is possible to produce the resin molding (extrusion molding) with smooth surface (outer circumferential face) and having the correct outside size.

In JP-A-2001-113587, an extrusion molding apparatus was disclosed in which a torpedo member is inserted into the molten resin flow channel of the die. However, the extrusion molding apparatus has the distal end not tapered, unlike this invention, and no meaning or action of tapering the distal end was described. The invention as disclosed in JP-A-2001-113587 is essentially different in the solving problems from this invention as disclosed herein.

Preferably, a pulling equipment is disposed downstream of the sizing equipment, in which the pulling equipment exerts a pulling force to the resin molding exhausted out of the sizing equipment.

According to the invention, the pulling equipment is activated, so that a pulling force (tensile force) is exerted to the shaped molding material (solid portion) moving within the sizing equipment. Thereby, the moving speed (i.e., pulling speed from the sizing equipment to the resin molding) of the shaped molding material within the sizing equipment is controlled to optimize the step (b) easily. For instance, when the discharge amount of molding material from the extruder is increased to increase the supply amount of the molten resin to the central part of the molding material, the shaped molding material being solidified is smoothly moved in a suitable condition of being pressed against the inner wall face of the flow channel without clogging the molding material within the shaping flow channel.

Also, such pulling force (tensile force) acts as a force to pull the surface of the shaped molding material away from the inner wall face of the flow channel. Therefore, the extrusion molding is smoothly effected even by using the molding material having a relatively large friction factor.

Accordingly, there may be an effect that the resin molding is smoothly pulled (exhausted), and the extrusion molding with smooth surface of desired shape is manufactured at high productivity.

Preferably, the pulling speed of the resin molding exhausted out of the sizing equipment is controlled so that the pressure within the die acting on the molding material in molten state that is introduced into the sizing equipment may be roughly constant.

According to the invention, when a variation in the discharge amount from the extruder occurs, the pressure level of supplying the molten resin suitable for producing the extrusion molding with smooth-surface is kept constant to stabilize the movement (flow) of the shaped molding material. Accordingly, the effects of the invention may be further enhanced.

Preferably, the heat conducting member is heated by a conductive heat from the die.

According to the invention, a heat from the die is easily conductive to the heat conducting member without providing any special heating means for the heat conducting member, and the heat is further conductive to the molding material flowing around the heat conducting member. Therefore, there may be an effect that the inside of the molding material introduced into the shaping flow channel is easily kept in excellent molten state.

The heat conducting member may be heated by its own heating element. By this, the heat conducting member (partly or totally) is caused to generate a heat, which is then conducted to the molding material around the heat conducting member. Accordingly, there may be an effect that the inside of the molding material introduced into the shaping flow channel is easily kept in excellent molten state. Even when the resin molding having a relatively small thickness and being easily solidified up to the inside is produced, its surface (outer circumferential face) is made smooth.

Preferably, the heat conducting member is disposed at the position of the orifice in the flow channel apart from the inner wall face of the molten resin flow channel around the member.

According to the invention, since the heat conducting member is located in the flow channel surrounding it, the molten resin (molding material) passing through the orifice is diverted and supplied to the shaping flow channel. Whereby, a disorder (e.g., in a direction cross to the extrusion direction) in the flow of molten resin is less likely to occur after passing the distal end (downstream side) of the heat conducting member. Accordingly, there may be an effect that the extrusion molding with smooth surface and having the shape of correct size (typically accurate structure without difference in the density between inside and outside) is produced stably.

Preferably, the molding material contains at least one of a powder like solid filler and fiber like solid filler. Herein, the “solid filler” means the filler that can be maintained in the solid state without melting or decomposing in a temperature range (i.e., temperature range usually employed in the extrusion molding) where the thermoplastic resin as the main component (matrix component) of the molding material can be molten. Also, the “powder like” is the term indicating the massive substance that is fine enough to mold the resin or keep the strength without hindrance (except a fine fibrous substance), and is not limited to the specific particle diameter or shape. For instance, fine flake like, bar-like, spherical, granular, and hollow milled powders are all contained within the category of power like solid filler in this specification.

According to the invention, the resin molding with smooth surface (outer face) having the shape of correct size is produced even by using the molding material containing a relatively large amount of solid filler. Therefore, there may be an effect that the strength of resin molding is increased, and the extrusion molding having excellent resource saving and recycling ability is manufactured using the appropriate content of solid filler.

The invention provides an apparatus for suitably performing the above manufacturing method, that is, an apparatus for molding an extrusion molding with a smooth surface from a molding material of thermoplastic resin, the apparatus including an extrusion die connected to an extruder and having a heating unit for heating a molten resin flow channel and the molding material flowing through the molten resin flow channel, and an orifice with a predetermined opening shape, a sizing equipment connected to the die and having a shaping flow channel with a smooth inner wall face having a cross-sectional shape conforming to the opening shape of the orifice, and cooling means for cooling the molding material passing through the shaping flow channel, and one or more heat conducting members for supplying heat to the molding material in molten state flowing through the flow channel, the heating conducting members being disposed within the molten resin flow channel, characterized in that the heating members are disposed in the longitudinal direction of the flow channel, a distal end of the heat conducting member being penetrated into the shaping flow channel beyond the orifice, and tapered.

With the manufacturing apparatus, the manufacturing method according to the invention can be suitably performed. Accordingly, the resin molding (extrusion molding) with smooth surface (outer face) having the shape of correct size (accurate structure without difference in the density between inside and outside) is produced.

Preferably, the manufacturing apparatus, further including a pulling equipment downstream of the sizing equipment, in which the pulling equipment exerts a pulling force to the resin molding exhausted out of the sizing equipment.

According to the invention, there may be an effect that the resin molding is smoothly exhausted (pulled), and the extrusion molding with smooth surface having desired shape is manufactured at high productivity.

Preferably, a heat insulation portion for restricting conduction of heat between the die and the sizing equipment is provided in a connected portion between the die and the sizing equipment.

According to the invention, the conduction of heat from the die to the sizing equipment is restricted. Therefore, there may be an effect that the temperature decrease around the orifice of the die is prevented, and the molding material introduced through the molten resin flow channel via the orifice into the shaping flow channel is kept in excellent molten state (typically molten state without increasing the viscosity to impede the stable flow).

Preferably, the heat conducting member is made of a material having a higher heat conductivity than the thermoplastic resin, and mounted on the die in a state where heat from the die is conductive.

According to the invention, there may be an effect that the inside of the molding material introduced into the shaping flow channel is kept in excellent molten state with a simple constitution of the apparatus without providing special heating means for the heat conducting member.

Prefarably, the heat conducting member generates a heat at least partly (e.g., the entire heat conducting member, or a part of heating conductor) when energized.

According to the invention, there may be an effect that the inside of the molding material introduced into the shaping flow channel is kept in excellent molten state by varying the amount of electricity to control the temperature simply. Therefore, according to the invention, if the resin molding has a relatively small thickness, it may be produced with smooth surface (outer circumferential face).

Preferably, the heat conducting member is disposed at the position of the orifice roughly in the center of the flow channel apart from the inner wall face of the molten resin flow channel around the member.

Accordingly, there may be an effect that the resin molding with smooth surface (outer circumferential face) having the shape of correct size is produced stably.

Preferably, the sizing equipment includes a plurality of cooling unit that are controllable independently; and the plurality of cooling units are disposed separately in the longitudinal direction of the shaping flow channel.

According to the invention, the shaping flow channel may be segmented into plural blocks according to the number of cooling units, in which the inside of shaping flow channel for each block is cooled in different manner (typically at different cooling temperature for each block). Therefore, there may be an effect-that the shaped molding material flowing through the shaping flow channel is prevented from being cooled excessively or deficiently, and suitable cooling is realized in each part.

### BRIEF DESCRIPTION OF THE DRAWINGS

The present invention may be more readily described with reference to the accompanying drawings:

FIG. 1 is a schematic explanatory view showing an extrusion molding apparatus (line) according to one embodiment of the present invention.

FIG. 2 is a longitudinal cross-sectional view showing the essence of the extrusion molding apparatus according to the embodiment of the invention.

FIG. 3 is a longitudinal sectional view for explaining a typical state of a molding material that is introduced from an orifice of a die into a shaping flow channel of the sizing equipment.

FIG. 4 is a cross-sectional view (only showing the inside of a flow channel) taken along the line IV-IV in FIG. 3.

FIG. 5 is a cross-sectional view (only showing the inside of flow channel) taken along the line V-V in FIG. 3.

FIG. 6 is a cross-sectional view (only showing the inside of flow channel) taken along the line VI-VI in FIG. 3.

FIG. 7 is a cross-sectional view taken along the line VII-VII in FIG. 1.

FIG. 8 is a cross-sectional view taken along the line VIII-VIII in FIG. 1, showing the structure of an extrusion molding (roof molding) according to one embodiment.

### DETAILED DESCRIPTION OF THE PREFERRED EMBODIMENTS

The preferred embodiments of the present invention will be described below. It will be understood to those skilled in the art that all the items (general items concerning the extrusion molding such as an operation method for the extruder) other than those specifically referred to in this specification and required to carry out this invention should be grasped as the design items based on the prior arts. This invention can be practiced based on the items as disclosed in this specification and shown in the drawings and the technical common sense in this field.

An extrusion molding produced by the manufacturing method of this invention has a long resin molding as the main body, but the presence or absence of other elements (accessory portion) may not be specifically limited. Also, the molding material for use may be composed of thermoplastic resin singly or principally (matrix), but other constituents may not be specifically limited.

The thermoplastic resin for use may be general-purpose resin or engineering resin (so-called engineering plastics), or crystalline or non-crystalline resin. As crystalline resin, for example, polyamide (PA) resin, polyacetal (POM) resin, polypropylene (PP) resin, polyethylene (PE) resin, polybutyrene terephthalate (PBT) resin, or polyethylene terephthalate (PET) may be used. As non-crystalline resin, for example, acrylonitrile-butadien copolymer (ABS) resin, acrylonitrile-ethylene-propylene rubber styrene copolymer (AES) resin, polycarbonate (PC) resin, polystyrene (PS) resin, polyphenylene oxide (PPO) resin, or polymethyl methacrylate (PMMA) resin may be used. Besides, polyvinyl chloride (PVC) resin, and polystyrene (PBT) resin in various grades may be used.

When the environment is taken into consideration, resin not containing halogen such as chlorine is preferred. From a viewpoint of recycle, olefin resins such as polyethylene and polypropylene are particularly preferred.

In addition, various thermoplastic elastomers (e.g., olefin, styrene and vinyl) are preferably used. Particularly, from the viewpoint of recycle, olefin thermoplastic elastomer (TPO) in which hard segment is olefin resin is preferable.

In practicing this invention, a molding material having one kind of thermoplastic resin as exemplified as the matrix component may be employed, or a molding material having polymer complex or polymer alloy composed of two or three kinds of thermoplastic resins as the matrix component may be employed.

Also, the molding material may contain- various sub-components. Such preferred sub-components may include powder like and/or fiber like solid fillers. The solid fillers of this kind may be employed without limitation, as long they have the stable properties (typically conventional fillers). For example, ceramic, powder (containing powder of various inorganic compounds such as talc, same in the following), carbon powder, wood flour, ceramic fiber, and carbon fiber. Or metal powder such as iron powder and fiber like organic powder composed of plant (e.g., cotton) may be employed. Preferred ceramic powder may be powder matter (typically 1 to 1000 μm in particle diameter) of oxide, silicate or carbonate. Examples of silicate include talc, clay, mica, and glass beads. From the viewpoint of higher strength, talc is particularly preferable. Examples of oxide include silica, alumina, titanium oxide, zinc oxide, magnesium oxide, and quartzite. Examples of carbonate include calcium carbonate and magnesium carbonate. Also, preferred examples of ceramic fiber include glass fiber, boron fiber, and silicon carbide fiber, which have a diameter of about 0.1 to 500 μm. Glass fiber is particularly preferable.

In preparing the molding material, the content (ratio) of the solid filler may be different with the kind of used filler and the uses of finally obtained extrusion molding. With the manufacturing method of the invention, the content ratio of solid filler may be 30 mass % or more (e.g., 30 to 50 mass %), or 40 mass % or more (e.g., 40 to 60 mass %) to produce a resin molding with smooth surface.

Also, the molding material may contain various auxiliary components, in addition to the solid filler. Such auxiliary components may include antioxidant, light stabilizer, ultraviolet absorbing agent, plasticizer, lubricant, coloring agent and flame retardant.

The molding material is prepared in a desired formulation by various methods as conventionally well known. For example, a mixture of thermoplastic resin and powder like filler at a predetermined ratio is kneaded by a kneading extruder and extruded into strands, which are then shaped like the pellet.

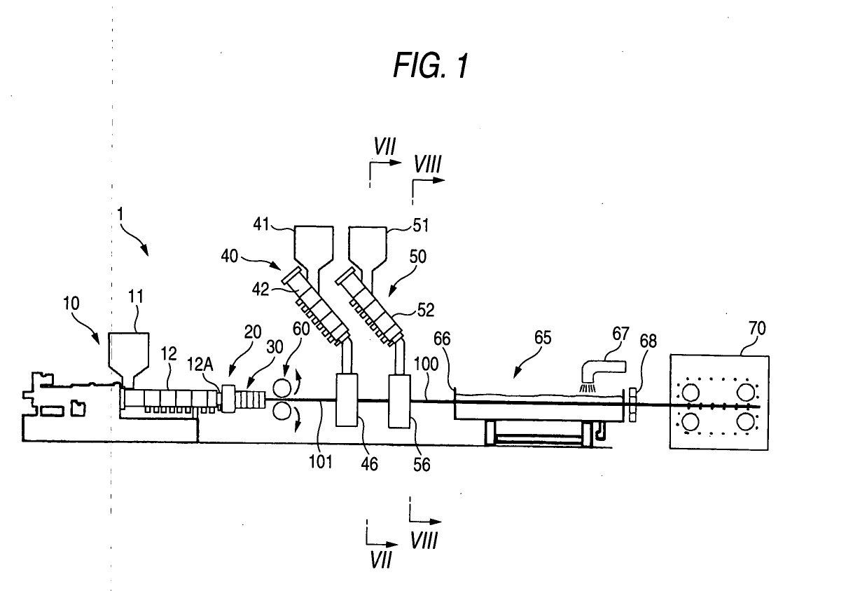

On preferred embodiment of the apparatus for manufacturing the extrusion molding by the manufacturing method of the invention will be described below with reference to the accompanying drawings. FIG. 1 is a schematic explanatory view showing an extrusion manufacturing line (extrusion molding apparatus) 1 according to one embodiment of the invention.

In this embodiment, an extrusion molding (roof molding for the vehicle) 100 including a long resin molding having a cross section as shown in FIG. 8 is produced.

As shown in FIG. 8, this molding 100 comprises a resin molding 101 (hereinafter referred to as a “main body portion 101”) having a cross section like a bridge. The main body portion 101 has a relatively thick and wide head portion 102, and a pair of leg portions 103A and 103B projecting from its bottom face. As will be described later, the head portion 102 and the leg portions 103A and 103B are integrally molded. Also, this molding 100 has a cover layer 104 so as to increase a weatherability and a scratch resistance on the surface of the head portion 102, and lips 106A and 106B that extend outwards on the outer side faces of the leg portions 103A and 103B.

The main body portion 101 is preferably made of a molding material containing olefinic thermoplastic resin (typically 40 to 60 mass %) such as polypropylene resin and powder solid filler (typically 60 to 40 mass %) such as wood flour. Though not specifically limited, the powder solid filler has preferably an average particle diameter of about 1 to 1000 μm. Also, the cover layer 104 has compatibility with the main body portion 101, and is preferably made of a molding material mainly containing polypropylene resin. The lips 106A and 106B as a mounting means on the vehicle body panel are preferably of a molding material mainly containing soft TPO (e.g., PP+EPDM).

For the sake of convenience, when not only the main body portion 101 after being solidified but also the molding material itself forming the main body portion 101 are referred to, the same numeral as the main body portion (resin molding) 101 is attached, whether the molten state or solid state, in the following explanation.

As shown in FIG. 1, there are provided an extruder 10, an extrusion molding die 20 connected to the distal end of the extruder 10, and the sizing equipment 30 on the upstream side of the manufacture line. Such extruder 10 (hereinafter referred to as a “first extruder 10”), the die 20 and the sizing equipment 30 are unit for performing the steps (a) and (b) as previously described, in which this unit corresponds to a manufacturing apparatus (hereinafter referred to as a “main body portion molding unit”) for the main body portion (resin molding) 101.

On the downstream side of the sizing equipment 30, there is disposed an extrusion molding die 46 connected to another extruder (hereinafter referred to as a “second extruder 40”). The second extruder 40, like the first extruder 10, comprises a hopper 41 and a heating cylinder 42 for melting the material and passing it to the distal end direction. They are a unit (hereinafter referred to as a “cover layer molding unit”) for extruding and molding the cover layer 104 on the surface of the main body portion 101 (head portion 102).

Moreover, on the further downstream side, there is disposed an extrusion molding die 56 connected to another extruder (hereinafter referred to as a “third extruder 50”). The third extruder 50, like the first and second extruders 10 and 40, comprises a hopper 51 and a heating cylinder 52 for melting the material and passing it to the distal end direction. They are a unit (hereinafter referred to as a “lip molding unit”) for extruding and molding the lips 106A and 106B on the outer side face of the main body portion 101 (leg portions 103A and 103B).

Moreover, as suitable additional devices in practicing the invention, the pulling equipment 60, a cooling device 65 and an extracting device 70 are provided as typically shown in FIG. 1.

First of all, the main body portion molding unit will be described below.

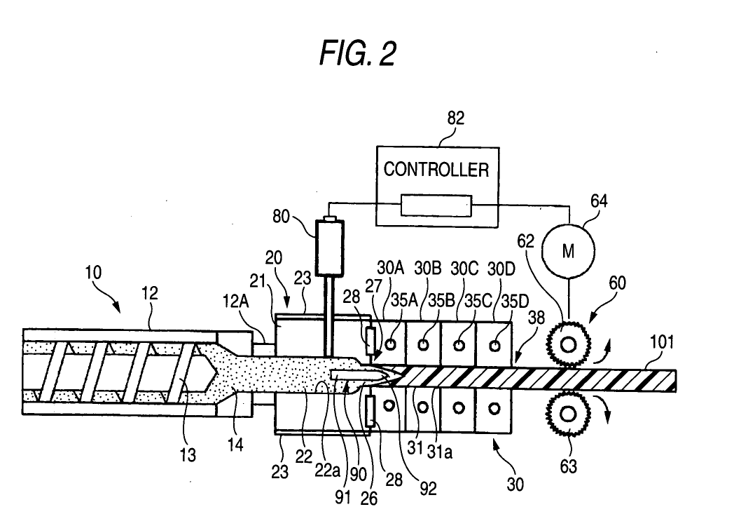

As shown in FIGS. 1 and 2, the first extruder 10 is a general single spindle extruder, comprising a hopper 11 for supplying a main body portion molding material like the pellet or other shape and a heating cylinder 12 having a screw 13 for melting the material and passing it to the distal end direction. A die 20 is mounted at a distal end 12A of the heating cylinder 12.

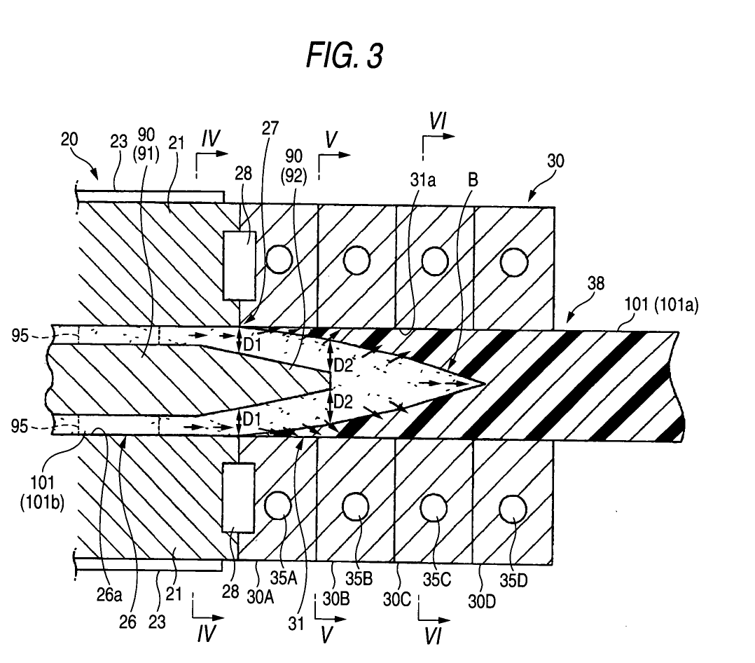

As shown in FIGS. 2 and 3, a molten resin flow channel 22 communicating to the flow channel 14 of the cylinder 12 is formed inside the die 20. The latter half part (downstream side) of the molten resin flow channel 22 is a land portion 26 having a smaller shape than the former half part (upstream side) At a top end of the land portion 26, an opening or orifice 27 for extruding the molding material is formed. The shape of the orifice 27 conforms to the shape of cross section of the main body portion 101. (see FIG. 8). Also, the inner wall faces 22a and 26a of the molten resin flow channel 22 (at least the land portion 26) are preferably smooth.

On the other hand, a band heater 23 for generating a heat when energized is provided around a metallic main body 21 of the die 20. The heat generated by the band heater 23 is conductive to the die main body 21 to heat the die 20 as a whole. Thereby, the molding material flowing through the flow channels 22 and 26 within the die 20 is heated to a desired temperature.

Also, a heat insulating portion (non-contact space portion in this embodiment) 28 is provided in a connecting portion with the sizing equipment 30 (typically around the orifice 27) to restrict heat conduction between the die 20 and the sizing equipment 30. That is, the band heater 23 and the heat insulating portion 28 prevent heat of the die 20 from being taken away by the connecting sizing equipment 30 to lower the temperature of the molten resin to increase the viscosity and solidify the resin, so that the molding material flowing around the land portion 26 and the orifice 27 is kept in a desired molten state at appropriate temperatures.

The surface of the sizing equipment 30 facing the die 20 is preferably formed with a so-called metallic brilliant face. Thereby, a radiant heat from the die 20 is reflected to suppress the rise in temperature of the sizing equipment 30 more effectively.

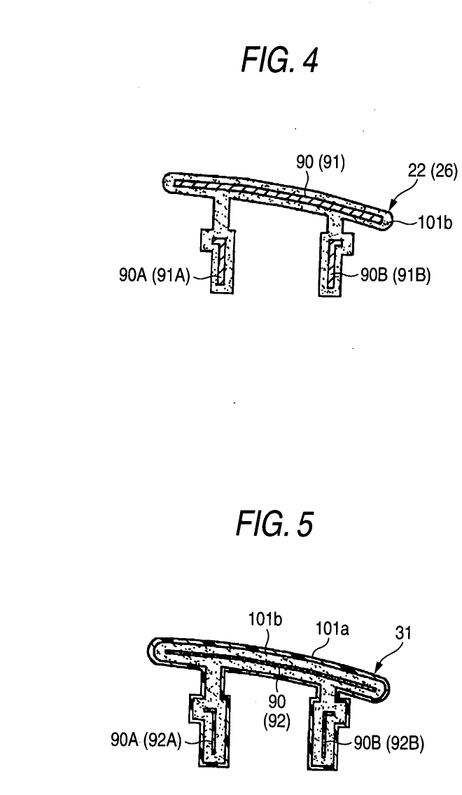

A heat conducting member 90 according to this embodiment is disposed within the molten resin flow channel 22, 26. That is, the heat conducting members 90, 90A and 90B made of metal and having a higher heat conductivity than the molding material are disposed in a portion corresponding to a head portion 102 in the flow channel 22 (land portion 26) and the portions corresponding to two leg portions 103A, 103B, respectively, as shown in FIG. 3 and FIG. 4, which is a cross-sectional view of the molten resin flow channel taken along the line IV-IV in FIG. 3.

As shown in the figures, the heat conducting members 90, 90A and 90B are formed in flat shape, and including the trunk portions 91, 91A and 91B connected to the extrusion die 20 and having a fixed area of cross section, and the tapered distal end portions 92, 92A and 92B, respectively. And the heat conducting members 90, 90A and 90B are disposed along the longitudinal direction of the flow channel (specifically in a state where the longitudinal direction of the heat conducting members 90, 90A and 90B and the longitudinal direction of the flow channel 26 are substantially equivalent, and typically in a state where the surface of the heat conducting members 90, 90A and 90B and the inner wall face 26a of the flow channel 26 are parallel in the positional relation). Also, at the position of the orifice 27, the molding material 101 is disposed to pass around the heat conducting members 90, 90A and 90B (herein spaced away from the inner wall face of the flow channel corresponding to the head portion 102 or the flow channel corresponding to the leg portions 103A and 103B and roughly in the center of the flow channels).

Also, the distal end portions 92, 92A and 92B of the heat conducting members 90, 90A and 90B are disposed to enter a shaping flow channel 31 beyond the orifice 27, as shown in FIG. 3 and FIG. 5, which is a cross-sectional view of the forming flow channel taken along the line V-V in FIG. 3.

Though the heat conducting member 90 disposed in a portion corresponding to the head portion 102 is shown in FIG. 3, the heat conducting members 90, 90A and 90B are attached via a metallic connecting member 95 having excellent heat conductivity to the die main body 21. Thereby, heat applied from the band heater 23 to the die main body 21 is rapidly conducted to the heat conducting member 90.

Moreover, preferably the heat conducting members 90, 90A and 90B contain an electric heater connected energizably to an external power source, not shown. Thereby, the temperature of the heat conducting members 90, 90A and 90B is simply adjusted by turning on and off electricity from the external power source to change the amount of electricity.

As shown in FIGS. 2 and 3, the shaping flow channel 31 having the shape of a fixed cross section communicating to the orifice 27 is formed inside the sizing equipment 30. The shaping flow channel 31 is formed to conform to the cross-sectional shape of the main body portion 101 (FIG. 8). An inner wall face 31a of the shaping flow channel 31 is subjected to mirror finish processing, and is a smooth surface having a surface roughness (maximum height: Rmax) of about 0.1 to 1 μm. The smoothness (roughness) of the shaping flow channel 31 is preferably equal to or more than the surface smoothness of the product (resin molding) obtained. The roughness of the shaping flow channel 31 is preferably equal to or less than the surface roughness (e.g., maximum height Rmax as the index) of the product (resin molding) obtained. Thereby, the molding having a smooth surface at the level of object is produced, and there is no entanglement with the inner wall face 31a of the shaping flow channel 31 when the molding material is moved downstream within the shaping flow channel 31, resulting in lower sliding resistance.

And the main body portion 101 of desired final shape is extruded from an exhaust opening 38 at the distal end (on the downstream side) of the shaping flow channel 31.

The sizing equipment 30 comprises several (four in this embodiment) cooling units 30A, 30B, 30C and 30D, each having cooling means controllable independently of each other. The cooling means according to this embodiment make up the coolant passages 35A, 35B, 35C and 35D, and are provided to surround the shaping flow channel 31. The inside of the sizing equipment. 30 is cooled to a desired temperature in each portion by passing coolant such as water through the coolant passages 35A, 35B, 35C and 35D. For example, when the inside of the shaping flow channel 31 is kept at 100° C. or less, water or hot water may be suitable, or when it is kept above 100° C., appropriate oil having a higher boiling point than water may be suitably employed. The coolant should be circulated between a temperature regulator such as a chilling machine, not shown, separately prepared and the sizing equipment 30 (cooling passages 35A, 35B, 35C and 35D). Thereby, the heat of the molding material (resin) is efficiently taken away.

As a result of the above constitution, with the main body portion molding unit, even when the molding material containing a large amount of solid filler is employed, the main body portion 101 (head portion 102 and leg portions 103A and 103B) having an excellent smooth surface and an accurate cross sectional shape can be produced. The detailed description is given below.

The main body portion molding material 101 extruded out of the first extruder 10 is extruded, in a state (specifically slurry or paste state) where the resin component is molten and the solid filler is dispersed, from the orifice 27 of the die 20 heated at a melting temperature or higher of the molding material to the shaping flow channel 31 of the sizing equipment 30. In this case, the temperature of the inner wall face 31a of the shaping flow channel 31 is adjusted below the melting point (preferably heat deformation temperature) of the matrix component (thermoplastic resin) of the molding material 101. Thereby, the molding material 101 extruded to the shaping flow channel 31 of the sizing equipment 30 is cooled from the outside, and gradually solidified toward the center. At this time, the molding material is solidified to be deformable by applying a force from the outside.

On the other hand, the heat conducting members 90, 90A and 90B are energized and heated up to the temperature above the melting point of the matrix component (thermoplastic resin component) of the molding material 101.

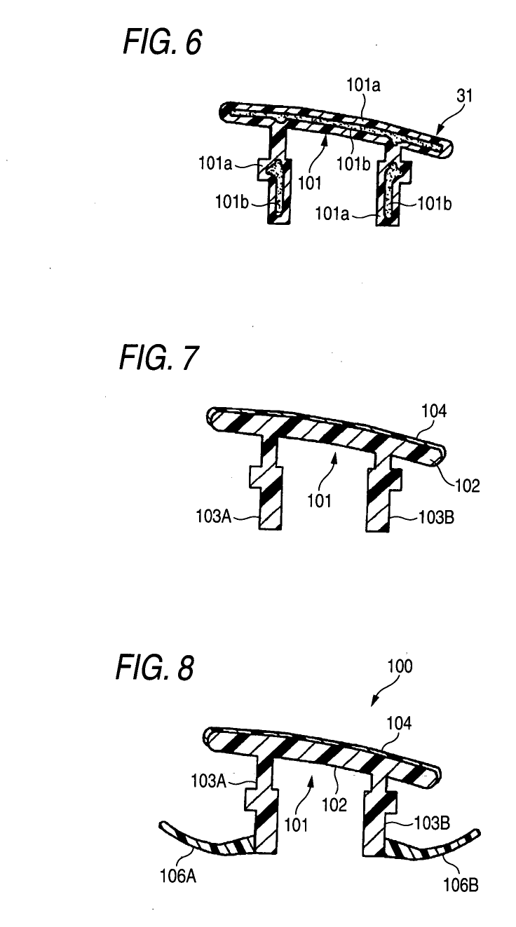

When heat is conducted from the heat conducting members 90, 90A and 90B to the molding material 101 flowing around them, the molten portion is retained inside the molding material 101 up to the area beyond the distal ends 92, 92A and 92B of the heat conducting members 90, 90A and 90B, as shown in FIGS. 3 and 6. A boundary line B as shown in FIG. 3 typically indicates the boundary between a solidified portion 101a (outside the boundary line B) of the shaped molding material 101 flowing through the shaping flow channel 31 and a molten portion 101b (inside the boundary line B).

As a result of a molten portion 101b remaining for a while inside the molding material 101 after entering the shaping flow channel 31 in the above way, the outer surface of the molding material 101 is pressed with the smooth inner wall face 31a of the shaping flow channel 31 due to a pressing force (expansion pressure) acting from the side of the first extruder 10. That is, as will be apparent from the boundary line B in FIG. 3, the molding material 101 passing through the orifice 27 is contact with the cooled inner wall face 31a of the shaping flow channel 31 and gradually solidified from a surface portion, its interior (central portion) being subject to an expansion pressure and kept in molten state for a while. At this time, the molten portion 101b that is not solidified yet is liquid, and subject to a pressure from a screw of the extruder. Therefore, the molten portion 101b has an expansion pressure (pressing force) that exerts all over the molten portion 101b in all directions. Thus, with such pressing force, the solidified surface 101a of the molding material 101 is pressed against the inner wall face 31a of the shaping flow channel 31 and acts as a force in the extrusion direction. The arrow in FIG. 3 typically indicates an expansion pressure (pressing force) of the molten portion 101b.

At this time, since the heat conducting members 90, 90A and 90B are tapered downstream of the shaping flow channel 31, the substantial area of the shaping flow channel 31 is enlarged, but the resin around the heat conducting members 90, 90A and 90B is kept in molten state, and moved downstream at a higher rate than on the surface due to a resin pressure from the extruder 10 to supplement an enlarged portion of the area, as shown in FIG. 3.

At this time, it is preferable to solidify the molding material 101, while compulsorily supplying and refilling a sufficient amount of molten resin to make up for a contraction amount of volume due to solidification under the condition where the molten portion 101b exists inside the molding material 101 up to the vicinity of the exhaust opening 38 (typically beyond two-thirds the total length of the shaping flow channel 31), as shown in FIG. 3. Thereby, it is possible to continue a pressure for pressing the surface onto the inner wall face 31a of the shaping flow channel 31 until the resin molding 101 is exhausted through the exhaust opening 38. And the molten resin component is continuously supplied from the die 20 and refilled to a finally solidified portion, as far as the molten state is retained. Thereby, when the resin component is solidified, that portion is contracted in volume, but a shortage of molding material due to this volume contraction is supplemented. As a result, a defective appearance such as sink mark is prevented from arising on the surface of the molding 101.

A preferred pressure of the molding material 101 against the inner wall face 31a of the shaping flow channel 31 is reflected (influenced) to the pressure of molding material within the molten resin flow channel 22 and a discharge pressure from the orifice 27 to the flow channel (shaping flow channel) 31 of the sizing equipment. Moreover, it may be varied depending on the shape of the die 20 and the orifice 27, the kind of resin component, and the content ratio of solid filler. Accordingly, a suitable pressure of the molding material 101 against the inner wall face 31a of the shaping flow channel 31 may be decided individually in consideration of the kind of used resin, the content ratio of solid filler, the shape of the die flow channel, the shape of orifice, and the extruding rate of molding material.

For instance, though not specifically limited, in the case of the molding material mainly composed of 40 to 50 mass % of olefin hard resin such as polypropylene and 60 to 50 mass % of solid filler such as wood flour and talc and the molding material mainly composed of 60 to 80 mass % of polyamide resin and 40 to 20 mass % of solid filler such as glass short fiber, it is necessary to set up the pressure within the die flow channel 22 for the molding material 101 at about 1 to 20 MPa (preferably 5 to 15 MPa). Those skilled in the art may easily make the set-up or adjustment of the extrusion rate (molding material supply rate) in consideration of the set heating temperature, the size of extrusion molding, the kind of resin constituent, and the heat capacity of resin based on the prior simulation or trial.

On the other hand, since the distal ends 92, 92A and 92B of the heat conducting members 90, 90A and 90B are tapered as above described, the extrusion manufacturing apparatus (manufacturing line) 1 according to this embodiment, the flow of the molten portion 101b is prevented from being excessively disordered in the sense and amount before and after passing by the distal ends of the heat conducting members 90, 90A and 90B. That is, variations in the expansion pressure of the molten portion 101b before and after passing by the distal ends of the heat conducting members 90, 90A and 90B are suppressed to a small value, so that the solidified outer portion is stably pressed with the inner wall face 31a of the flow channel.

Preferably, the taper shape of the heat conducting member, the flow rate of molding material and/or the cooling degree of the sizing equipment are adjusted so that the area of the molten portion 101b in cross section of the shaping flow channel 31 may be gradually increased from the time (D1) of passing the orifice 27 to the time (D2) of passing the distal ends of the heat conducting members 90, 90A and 90B, as shown in FIG. 3. Thereby, the stabler flow of the molten portion 101b within the shaping flow channel 31 is realized, so that the outer surface of the molding material 101 (101a) is pressed onto the inner wall face 31a of the shaping flow channel 31 more stably.

The extrusion molding is performed in the above way while the solidified surface of the molding material 101 is pressed onto the inner wall face 31a, whereby the protrusion of solid filler is physically blocked to form a smooth surface abundant in the matrix component (resin component) transferring the smoothness of the inner wall face 31a.

And the resin molding with smooth surface 101 (herein the main body portion) is exhausted through the exhaust opening 38 at the trail end (downstream side) of the shaping flow channel 31 in the sizing equipment 30.

Then, a cover layer molding unit will be described below. As shown in FIG. 1, the main body portion 101 solidified and molded within the shaping flow channel 31 of the sizing equipment 30 is continuously supplied to an extrusion die 46 (second extrusion die)of the cover layer molding unit. The die 46, like the die for use with general multistage extrusion, communicates to a cylinder 42 of the second extruder 40, so that a cover layer molding material having higher weatherability and higher scratch resistance than the main body 101 and molten within the cylinder 42 is supplied to the die 46. The cross-sectional shape of the orifice not shown for this die 46 is matched with the cross-sectional shape of the total of the main body portion 101 and the desired cover layer 104. Thereby, the cover layer 104 of predetermined cross-sectional shape is formed on the upper face of the head portion 102 from the cover layer molding material supplied to the die 46, as shown in FIG. 7.

And the resin molding in which the cover layer 104 is formed on the surface of the main body portion 101 as shown in FIG. 7 is extruded through an extrusion opening not shown of the die 46.

As above described, the surface of the main body portion 101 forms the smooth surface abundant with resin component, whereby a larger contact area between the resin component in the cover layer molding material supplied and the resin component on the surface of the main body portion is secured. Therefore, the cover layer 104 is formed and bonded by fusion welding at high bonding strength outside the main body portion 101 (head portion 102). This effect is particularly remarkable in the case where the resin component composing the main body portion 101 is compatible with the resin component composing the cover layer 104.

Also, in the case where the resin component composing the main body portion 101 and the resin component composing the cover layer 104 are incompatible, the surface of the main body portion 101 (at least a portion containing the surface of the head portion 102 to form the cover layer) before being supplied to the die 46 of the cover layer molding unit is given an appropriate primer (adhesive), whereby the cover layer 104 is adhered outside the main body portion 101 at high bonding strength in the same way as the case with compatibility. For example, when polypropylene resin (matrix for main body portion) and TPO (cover layer matrix) having PP (polypropylene resin) as the hard segment are bonded, solvent primer for bonding PP, available on the market, (e.g., available from Jujo Chemical Co., Japan) is coated on the surface of the main body portion 101, and dried, thereby forming a dried primer film on the surface of the main body portion 101. Since the surface of the main body portion 101 produced by this invention is smooth, the primer film is formed smoothly on its surface. Thereby, the cover layer 104 is formed at high bonding strength on the surface of the main body portion 101 even by a combination of resins that are difficult to fuse together essentially. Such a primer processing itself may be performed using conventionally well-known materials and methods, but not specifically limited.

A lip molding unit will be described below. The constitution of this lip molding unit is roughly the same as the cover layer molding unit, above described. That is, the molding (FIG. 7) extruded from the second extrusion die 46 of the cover layer molding unit is continuously supplied to an extrusion die 56 (third extrusion die) of the lip molding unit, as shown in FIG. 1. This die 56 communicates to the cylinder 52 of the third extruder 50, so that the lip molding material molten within the cylinder is supplied to the die 56. The cross-sectional shape of the orifice not shown of this die 56 is matched with the cross-sectional shape of the final extrusion molding, namely, the total of the main body portion 101, the cover layer 104, and a pair of lips 106A, 106B. Thereby, the lips 106A and 106B of predetermined cross-sectional shape are formed from the lip molding material, which is softer and more elastic than the main body 101 supplied to the die 56 on the outer side face of both the leg portions 103A and 103B, respectively, as shown in FIG. 8.

And the resin molding (roof molding for vehicle) 100 of cross-sectional shape is extruded through the extrusion opening not shown of the die 56, as shown in FIG. 8.

The appropriate primer processing may be made in the same way as when molding the cover layer, depending on the kind of thermoplastic resin composing the lips, before introducing the resin molding (main body portion 101 plus cover layer 104) into the die 56.

Incidentally, the lips 106A and 106B function as mounting means to the main body panel.

As above described, the resin extrusion molding (roof molding) 100 according to this embodiment of FIG. 8 is manufactured by a so-called multistage extrusion using the main body portion molding unit, the cover layer molding unit and the lip molding unit.

The pulling equipment 60, the cooling device 65 and the extraction device 70 provided on the manufacturing line according to this embodiment will be described below.

The pulling equipment 60 as shown in FIG. 1 is the device for pulling the resin molding 101 out of the sizing equipment 30. As shown in FIG. 2, the pulling equipment 60 according to this embodiment comprises a pair of rollers 62 and 63 rotationally driven by a drive source (typically an electric motor with controllable revolving speed). The resin molding 101, which is pressed against and sandwiched between the pair of rollers 62 and 63, is pulled out of the sizing equipment 40 in accordance with the revolving speed. By providing this pulling equipment 60, the resin molding 101 is exhausted stably, even if there is a great friction within the sizing equipment.

Also, the pressure within the flow channels 22, 26 and 31 is kept constant by controlling the revolving speed (pulling speed) of the rollers 62 and 63.

At this time, preferably, there is provided a pressure sensor 80 for detecting the pressure of molding material flowing through the flow channel 22 of the die 20, this sensor 80 being electrically connected to a controller (typically a microcomputer with CPU) 82, as shown in FIG. 2. Moreover, the controller 82 is connected controllably to the drive source (motor) 64 of the pulling equipment 60. With this constitution, the controller 82 is operated as a motor driver for driving the rollers 62 and 63 of the pulling equipment 60. As a result, a pressure of the molding material 101 exerting on the inner wall face 22a of the molten resin flow channel 22 for the die 20 is detected, the drive source (revolving speed of the motor) for the pulling equipment 60 is controlled on the basis of its detected value, and the revolving speed of the rollers 62 and 63 is appropriately increased or decreased in accordance with a variation in the pressure. Thereby, the pressure of the molding material 101 flowing through the molten resin flow channel 22 of the die 22 is kept constant, so that the pressure of the shaped molding material 101 against the inner wall face 31a of the shaping flow channel 31 is automatically maintained in a suitable range (e.g., suitable for forming the smooth surface and preventing sink mark from occurring).

For example, the following control is performed as one specific example. That is, the controller 82 receives a pressure signal from the pressure sensor 80 at regular intervals continuously. And when the received pressure signal corresponds to a preset pressure level (e.g., 7±0.1 MPa, hereinafter referred to as an “initial pressure level”), the motor 64 is controlled to pull out the resin molding 101 at an initially set pulling speed (e.g., 3 m/min, hereinafter referred to as an “initial pulling speed”). However, when a pressure signal indicating a higher pressure than the initial pressure level is received due to some cause, the motor 64 is controlled to raise the revolving speed of the rollers 62 and 63 so that the pulling speed may be greater than the initial pulling speed. Thereby, the pressure of the molding material 101 against the inner wall face 31a of the shaping flow channel 31 is prevented from being continuously raised above a permissible level (e.g., beyond 7.1 MPa).

On the other hand, when a pressure sensed signal indicating a lower pressure than the initial pressure level is received due to some cause, the motor 64 is controlled to decrease the revolving speed of the rollers 62 and 63 so that the pulling speed may be less than the initial pulling speed. Thereby, the pressure of the molding material 101 against the inner wall face 31a of the shaping flow channel 31 is prevented from being decreased below the permissible level (e.g., less than 6.9 MPa).

Also, the cooling device 65 as shown in FIG. 1 comprises a cooling pool 66 for cooling the resin extrusion molding 100 and a cooling water supply source 67 for supplying cooling water to the cooling pool 66. With this arrangement, the resin extrusion molding 100 pulled out of the die 56 is promptly introduced into the cooling pool 66 to fully cool the entire molding. Excess water content adhering to the resin extrusion molding 100 taken out from the cooling pool 66 is removed by an air cutter (blower) 68.

The extracting device 70 is disposed downstream of the cooling device 65 to extract and withdraw the resin extrusion molding 100 from the cooling device 65 (cooling pool 66). The withdrawn resin extrusion molding 100 is cut into a predetermined length by a cutting device, not shown.

Though the preferred embodiments of the invention have been described above with reference to the accompanying drawings, the contents of the invention may not be limited to the above embodiments.

For example, when the main body portion molding unit is used, the cooling units 30A, 30B, 30C and 30D may be set at different cooling temperatures by passing the coolants having different temperatures in the sizing equipment 30 through the passages 35A, 35B, 35C and 35D, respectively. For example, an upstream region near the orifice 27 may be set at a slightly higher temperature, and a downstream region may be adjusted at a relatively lower temperature. By providing a gradient in the cooling temperature, the molten portion 101b within the molding material is easily maintained in an upstream region and a midstream region of the shaping flow channel 31 (preferably, up to two-thirds the total length of the shaping flow channel 31 from an upstream entrance as shown in FIG. 3), so that the surface of the molding material 101 is effectively pressed against the inner wall face 31a of the shaping flow channel 31 via a remaining molten portion 101b in the upstream region. Thereby, the smoothness of the surface for the main body portion and the correctness of shape size (prevention of occurrence of sink mark) are implemented at higher degree.

Also, in the extrusion manufacturing line 1 according to the embodiment, the pulling equipment 60 is provided to adjust the moving speed of the resin molding 101 so that the pressure of extrusion die may be constant. However, the moving speed of the resin molding (shaped molding material) 101 may be adjusted by increasing or decreasing the amount of extruding (supplying) the molding material 101 from the extruder 10 without providing this pulling equipment 60.

Also, the pair of rollers 62 and 63 mounted on the pulling equipment 60 are not specifically limited in the surface shape and the material as long as they can adjust the moving speed of the resin molding 101 by carrying it without causing any slip. For example, if the roller (made of steel) having irregularities formed on the outer circumferential face by knurling is employed, a pulling force is surely applied without causing slip between the roller and the resin molding. The rollers are not limited to one pair, but may be provided by two or more pairs.

Also, when the resin molding is made of soft material on the surface, unpreferable trace is prevented from occurring on the surface of the molding by being sandwiched between the rollers. Therefore, the roller is desirably made of rubber. Or instead of the cylindrical roller, the rubber belt or crawler transporter (caterpillar) may be employed.

In the above embodiment, the roof molding for vehicle 100 has been exemplified as shown in FIG. 8. However, various shapes of extrusion moldings may be manufactured other than the roof molding.

Though this invention has been described above in detail, the embodiments of the invention are only illustrative, and the invention is only limited by the claims. Various changes or modifications of the techniques may be made within the scope or spirit of the invention as defined in the claims.

Also, the technical elements as described in this specification or the drawings reveal the technical availability singly or in various combinations, but are not limited to the combinations as defined in the claims at the time of application. Also, the techniques as illustrated in the specification or the drawings can accomplish plural objects at the same time, whereby the technical availability is provided by achieving one of the objects.

What is claimed is:

1. A method for manufacturing an extrusion molding with a smooth surface, comprising:
(a) supplying a molding material of thermoplastic resin to an extrusion molding apparatus, the extrusion molding apparatus including: an extrusion die connected to an extruder and having a molten resin flow channel for flowing a heated and molten resin and an orifice with a predetermined opening shape, a sizing equipment connected to the die and having a shaping flow channel with a smooth inner wall face having a cross-sectional shape conforming to the opening shape of the orifice, one or more heat conducting members for supplying heat to the molding material in a molten state flowing through the flow channel disposed in the longitudinal direction of the flow channel within the molten resin flow channel of the die, a distal end of the heat conducting member being penetrated into the shaping flow channel beyond the orifice, and tapered; and
(b) exhausting a resin molding having a predetermined cross-sectional shape substantially in a solid state out of the sizing equipment by introducing the molding material in molten state through the orifice into the sizing equipment to surround the heat conducting member and passing the molding material while cooling the molding material from the outer surface side by contact with an inner wall face of the shaping flow channel, in which the temperature of the inner wall face is adjusted to a lower temperature than a melting temperature of the molding material;
wherein the step (b) includes retarding the cooling of the molding material around the heat conducting member by supplying a heat from the heat conducting member to the molding material to leave a molten portion within the molding material at the time of passing the distal end of the heat conducting member, whereby the surface of the molding material is pressed against the inner wall face of the shaping flow channel due to an expansion pressure of the molten portion to form a smooth outer surface of the molding, the molding material being solidified while being moved downstream.

2. The manufacturing method according to claim 1, wherein a pulling equipment is disposed downstream of the sizing equipment, in which the pulling equipment exerts a pulling force to the resin molding exhausted out of the sizing equipment.

3. The manufacturing method according to claim 2, wherein the pulling speed of the resin molding exhausted out of the sizing equipment is controlled so that the pressure within the die acting on the molding material in molten state that is introduced into the sizing equipment may be roughly constant.

4. The manufacturing method according to claim 1, wherein the heat conducting member is heated by a conductive heat from the die.

5. The manufacturing method according to claim 1, wherein the heat conducting member is heated by its own heating element.

6. The manufacturing method according to claim 1, wherein the heat conducting member is disposed at the position of the orifice in the flow channel apart from the inner wall face of the molten resin flow channel around the member.

7. The manufacturing method according to claim 1, wherein the molding material contains at least one of a powder like solid filler and a fiber like solid filler.

8. The manufacturing method according to claim 7, wherein in the step (b), the surface of the molding material is pressed against the smooth inner wall face of the shaping flow channel so that the at least one of a powder like solid filler and a fiber like solid filler does not protrude from the surface of the molding material.

9. The manufacturing method according to claim 1, wherein the molding material contains crystalline thermoplastic resin.

10. The manufacturing method according to claim 9, wherein the crystalline thermoplastic resin contains at least one of polyamide (PA) resin, polyacetal (POM) resin, polypropylene (PP) resin, polyethylene (PE) resin, polybutyrene terephthalate (PBT) resin and polyethylene terephthalate (PET) resin.

11. The manufacturing method according to claim 1, wherein in the step (b), smoothness of the inner wall face of the shaping flow channel is transferred to the molding material so that the smooth surface of the molding is formed.

12. The manufacturing method according to claim 1, wherein the step (b) includes supplying molten resin material into the extrusion molding with a volume compensable a volume contraction of the molding material due to solidification in the shaping flow channel.

13. The manufacturing method according to claim 12, wherein supplying molten resin material into the extrusion molding includes making the molten resin material around the heat conducting member flow at a rate higher than the molten resin material on the surface of the molding material.

14. The manufacturing method according to claim 1, wherein the heat conducting members are provided on a plurality of positions.

15. The manufacturing method according to claim 1, wherein in the step (b), the heat conducting member is pre-heated to a temperature higher than the melting temperature of the molding material.

16. The manufacturing method according to claim 1, further comprising:
(c) supplying the resin molding to a second extrusion die disposed downstream of the extrusion die to form the extrusion molding having an attachment portion made of a resin material different from the molding material;
wherein the attachment portion is integrated with the resin molding when the resin molding passes through the second extrusion die.

17. The manufacturing method according to claim 16, wherein the attachment portion is formed as a cover layer for covering the surface of the extrusion molding.

18. The manufacturing method according to claim 16, wherein the attachment portion is formed as a lip that protrudes from a portion of the extruding molding.

19. An apparatus for molding an extrusion molding with a smooth surface from a molding material of thermoplastic resin, the apparatus comprising:
an extrusion die connected to an extruder, the extrusion die having a molten resin flow channel, a heating unit that heats the molding material flowing through the molten resin flow channel, and an orifice with a predetermined opening shape;
a sizing equipment connected to the die, the sizing equipment having a shaping flow channel with a smooth inner wall face having a cross-sectional shape conforming to the opening shape of the orifice and the cooling unit that cools the molding material passing through the shaping flow channel; and
at least one conducting member for supplying heat to the molding material in molten state flowing through the flow channel, the heating conducting members being disposed within the molten resin flow channel;
wherein the at least one heating member is disposed in the longitudinal direction of the flow channel, a distal end of the heat conducting member being penetrated into the shaping flow channel beyond the orifice, and tapered.

20. The manufacturing apparatus according to claim 19, further comprising: a pulling equipment disposed downstream of the sizing equipment;
wherein the pulling equipment exerts a pulling force to the resin molding exhausted out of the sizing equipment.

21. The manufacturing apparatus according to claim 19, further comprising: a heat insulation portion for restricting conduction of heat between the die and the sizing equipment;
wherein the heat insulation portion is provided in a connected portion between the die and the sizing equipment.

22. The manufacturing apparatus according to claim 19,
wherein the at least one heat conducting member is made of a material having a higher heat conductivity than the thermoplastic resin, and mounted on the die in a state where heat from the die is conductive.

23. The manufacturing apparatus according to claim 19,
wherein the at least one heat conducting member generates a heat at least partly when energized.

24. The manufacturing apparatus according to claim 19,
wherein the heat conducting member is disposed at the position of the orifice substantially in the center of the flow channel apart from the inner wall face of the molten resin flow channel around the member.

25. The manufacturing apparatus according to claim 19,
wherein the sizing equipment includes a plurality of cooling units that are controllable independently; and
the plurality of cooling units are disposed separately in the longitudinal direction of the shaping flow channel.
